(19) United States
(12) Patent Application Publication
(10) Pub. No.: US 2015/0039457 A1
(43) Pub. Date: Feb. 5, 2015

(54) SYSTEM FOR SYNDICATING SUBSCRIPTIONS WITH RETAILERS

(71) Applicant: Microsoft Corporation, Redmond, WA (US)

(72) Inventors: Daniel Jacobs, Dublin (IE); Pieter Retief Kasselman, Dublin (IE); David Mowatt, Dublin (IE)

(73) Assignee: Microsoft Corporation, Redmond, WA (US)

(21) Appl. No.: 13/956,362

(22) Filed: Aug. 1, 2013

(51) Int. Cl. G06Q 30/06; G06Q 20/22

(52) U.S. Cl. CPC G06Q 30/0601; G06Q 20/22; G06Q 30/0613
USPC 705/26.1; 705/26.41

(57) ABSTRACT

System and methods for facilitating syndication of subscriptions with retailers are described. The retailer can manage the customer relationship and may optionally automatically renew the customer's subscription. The platform fulfilling the subscription receives payment from a retailer and provisions the renewal subscription to the customer. A customer can purchase an entitlement card from the retailer. The entitlement card can be for a subscription redeemable through a platform holder system (via entry of a token) and includes (or is assigned) an indicator of the retailer that sold the card. The indicator can be used by the platform fulfilling the subscription to provide a differentiated or customized experience for a customer based on the retailer at which the subscription was purchased. Third-party providers can use the platform to syndicate their products and services with retailers.

### BACKGROUND

The software industry is transitioning from a model of selling boxed software with a perpetual license to selling subscriptions for software and services that have a duration that eventually expires. Automatic renewal of subscriptions, where a customer is automatically billed at the expiration of the subscription, can ensure the continuity of service.

Currently, for online services such as anti-virus software, a customer may purchase a subscription with an automatic renewal policy or be prompted by the anti-virus software to renew the subscription. However, this process is via a direct channel. That is, the service or product provider prompts the customer to renew that service or product and/or automatically charges the customer according to a renewal policy. Thus, infrastructure and arrangements supporting sales and renewal of subscriptions outside of direct channels as well as through resellers may be a next avenue for development.

### BRIEF SUMMARY

This disclosure is directed to methods, systems, and solutions for syndicating subscriptions with retailers. System and methods are described for enabling retailers to sell subscription products or services to customers, where those products or services are provided (and/or fulfilled) by another company—a Platform Holder or a Third-party Provider.

In one implementation, a physical box (or other package) advertising a third party service/product subscription may be available for sale by a retailer. A customer may purchase the physical box (or other package) from the retailer to pay for the subscription to the third party service/product. The retailer can manage the customer relationship and may optionally be able to automatically renew the customer's subscription when authorized at the original subscription purchase or contact the customer at subscription expiration to renew the subscription.

In one implementation, the physical box (or other package) includes an entitlement card (a representation of subscription benefits). The entitlement card presents a substrate for a token or other product key for a subscription redeemable through a platform holder system. The token can be assigned or includes an indicator of the Retailer that sold the card. The indicator of the Retailer can be used by a Platform Holder or other entity fulfilling the subscription to provide a differentiated or customized experience for a customer based on the Retailer at which the subscription was purchased.

In another implementation, a system is provided that enables retailers to automatically renew subscriptions of products or services for customers who initially purchased with that retailer. The system may be used for digital and non-digital products and services in order to enable such products and services to be sold in a syndicated manner. The system may include a platform holder system and service.

Through the platform holder system and service, Third-party providers can sell subscriptions that may optionally be automatically renewed via a retail channel. Fulfillment of the third-party application subscription may be carried out by the Platform Holder system or the Third-party provider. In some cases, communication about billing events such as the upcoming expiry of a subscription (or upsell to a premium subscription) is handled by the Retailer, in others by the Platform Holder or by the Third party.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1D illustrate a process flow for recognizing the retailer when selling token-based subscriptions.

FIGS. 2A-2C illustrate a process flow for facilitating renewal of subscriptions via a retailer.

FIGS. 3A-3D illustrate a process flow for facilitating renewal of Third-party subscriptions via a retailer.

FIG. 4 illustrates a general operating environment.

FIG. 5 illustrates an operating environment in which certain implementations may be carried out.

FIG. 6 illustrates an operating environment in which certain implementations may be carried out.

FIGS. 7A and 7B illustrate implementations of a method for facilitating syndication and renewal of subscriptions via a retailer.

FIGS. 8A-8C illustrate a process flow for facilitating renewal of subscriptions via a retailer.

### DETAILED DESCRIPTION

This disclosure is directed to methods, systems, and solutions for syndicating subscriptions with retailers.

Certain embodiments contemplate using redemption tokens through offline and online retailers to sell subscriptions for products and services. A “token,” or “redemption token” (which may be used interchangeably herein), refers to a unique identifier used to access and redeem an entitlement. A unique identifier refers to an identifier that is exclusively associated with a single entity within a given system. The token may be a series of characters or string of number and/or letters (e.g., an alpha-numeric identifier). A user (or an entity acting on behalf of the user) may enter the token, for example, via a redemption interface in order to redeem the benefits to which the token entitles the user to access or obtain.

Redemption tokens of certain implementations generally involve a substrate on which the token is contained. The substrate may be provided as an entitlement card or a physical box or other package. The substrate may be a card, box, paper or other physical implement on which a token is readable.

The redemption token may be human readable (by being printed or stamped) or machine readable (such as by magnetic strip or radio frequency transmission). In some cases, the redemption token can be provided to a customer (e.g., the end-user who purchases subscription-based products/services at a Retailer) in a form that is not on a physical card or substrate. For example, the redemption token may be sent to a customer in a message, email, or by some other form of communication.

According to various implementations, a redemption token may be delivered electronically or printed on a card and sold by a Retailer at a brick and mortar store or mailed to a customer in the case of online retail. In one implementation, the token may be provided on an entitlement card or other packaging in a manner that is revealed upon scratching off an opaque substance covering the token information. In another implementation, a Retailer point of sale system may recognize that an entitlement card (or other package or physical box representing a subscription for a service or product) has been purchased, and may provision the appropriate redemption token dynamically, either printing the token on a receipt, emailing the token, messaging the token, or by some other suitable manner. For example, the box may include a barcode that describes the product; and when the barcode is scanned at the point of sale system, a token may be provisioned to the customer with an indicator of the Retailer that sold the card. A Retailer refers to a retail partner of a product producer or distributor that sells products and services to customers, either online or in a brick and mortar store.

After purchase, the token may be redeemed for the subscription product/services with a Platform Holder. A Platform Holder provides a distribution system which may distribute software products and/or services. The Platform Holder may also provide an application programming interface (API) to enable the functionality described herein to be accessed by a variety of systems. A Platform Holder may be an operator of an ‘app store.’ Retailers include any merchants that provide products and services directly to an end user, including large and small retail stores, original equipment manufacturers (OEMs) telecommunication providers and even other app stores (who themselves may function as a Platform Holder in some cases).

The software products and/or services distributed by the Platform Holder may be developed or owned by the Platform Holder (i.e., first-party software). In some implementations, the systems also enable software developed and/or owned by a Third-party Provider to be distributed by the Platform Holder. A Third-party Provider refers to an entity that provides subscription-based software/services via a Platform Holder's ‘app store’. The Third-party Provider may be a developer.

A token grants a Customer access to a benefit of a specific subscription-based product/service. That product/service may be from a first-party (from the Platform Holder) or from a Third-party Provider.

As used herein, a token is not a form of stored value that grants the holder access to an arbitrary product/service from the Platform Holder's catalog. Rather, a token is assigned a specific benefit and is redeemed for that specific benefit. In addition, according to embodiments of the invention, the token is further assigned to a specific Retailer.

According to various embodiments, the entitlements to which the described entitlement cards (and other packaging) are directed involve subscriptions to an online service or other product that may be syndicated.

The software industry is transitioning to a model whereby software is distributed electronically via App Stores, which are operated by Platform Holders. Examples of Platform Holders and App Stores include Apple Inc. with iTunes®, Microsoft Corp. with Windows® Store, Amazon.com, Inc. with Amazon® Appstore, and Google, Inc. with Google Play®.

Even with the transition to App Stores, retailers—both brick and mortar (B&M) and online—continue to be an important distribution channel for software. It can be a challenge to continue to distribute software as well as other products and subscriptions that may be fulfilled via online methods through retailers. One consideration is the relationship between the retailer and the customer, which should be maintained and facilitated.

Today, a customer can purchase a pre-paid entitlement card for a subscription service or product from a retailer. The entitlement may be a subscription for one year, but different terms may be available, including month-to-month and custom terms. Once purchased from a retailer, the token contained on (or otherwise associated with) the entitlement card can be redeemed and activated from home (or work) through an entity fulfilling the subscription. This may be the Platform Holder and/or the service/product provider. Order fulfillment refers to providing the service; allowing user to download or access a product/item or allowing the user to access a service or product.

Implementations enable Platform Holders and Third-party Providers of software to sell subscriptions to their products and services through retailers, even if those products and services are ultimately fulfilled via a system operated by a Platform Holder. The subscriptions can be sold in the form of a physical box or other package advertising Platform Holder or Third-party service or product subscriptions. Instead of prompting the customer to renew their subscription in the direct channel (i.e., through communication initiated online or otherwise with the Platform Holder and/or service/product provider), embodiments facilitate the maintaining of the customer-retailer relationship. This may minimize the dis-incentivization for selling subscriptions that can occur when the retailer is left out of the loop after the initial sale of the entitlement card.

Redemption tokens can be configured by the Platform Holder to be associated with the retailer to whom the token is provided. Entitlement cards and other subscription packaging for the redemption tokens can include a code, information, or other identifier indicating the retailer selling the card. The code, information, or other identifier indicating the retailer selling the card may be explicit so that inspection of the code, information or other identifier can reveal the retailer associated with the redemption token. In other cases, the code, information, or other identifier indicating the retailer selling the card is implicit in the redemption token such that inspection of the redemption token may not reveal the retailer, instead the redemption token indicates the retailer upon review of a database or other memory storing the relationship between the redemption token and the retailer.

The information regarding the retailer for a particular redemption token is used to customize the customer experience. This information can help the platform system promote and/or facilitate the customer relationship management (CRM) relationship between the Retailer and the customer, including the ability to send marketing emails and have links in-product to renew the subscription that will take customers to the retailer's site to renew, instead of platform holder and/or service/product provider's site.

As one approach, the entitlement syndication systems described herein enable the separation of a billing relationship and a fulfillment relationship with a user.

Syndication refers to allowing party A to sell a subscription to a product/service provided by party B, which may or may not be fulfilled via party C. As applied to implementations described herein, party A is the retailer, the subscription is one that party A may automatically renew, and party C is the platform holder.

Similar to the content syndication model used with news and entertainment, where content such as news articles and television shows originating in one platform or forum are made available to another forum through distribution channels, certain embodiments apply this model to products and services in a manner where the content (here the product or service) is syndicated to a retailer. The retailer can package and provide the product or service. In another implementation, the retailer may sell a physical card that is packaged/produced by the platform holder or third party.

A system is provided that allows retailers to automatically renew subscriptions of their customers who initiate purchase at the retailer. The system can recognize when a subscription is sold by a retailer because the tokens indicate that they are owned by that retailer. Then when the token is redeemed, it is recognized that the token comes from the retailer. The retailer has the billing engine that keeps track of whether a customer's subscription is about to expire, contacts the customer, and initiates the renewal. The platform holder fulfills the order.

An API is provided that enables retailers to collect information for automatic renewal of the customer's subscription at the end of the subscription period. At expiration time, it is the retailer that collects payment from the customer's on-file payment instrument. The retailer can contact the fulfillment entity via the API to provision the user's subscription with an additional subscription period.

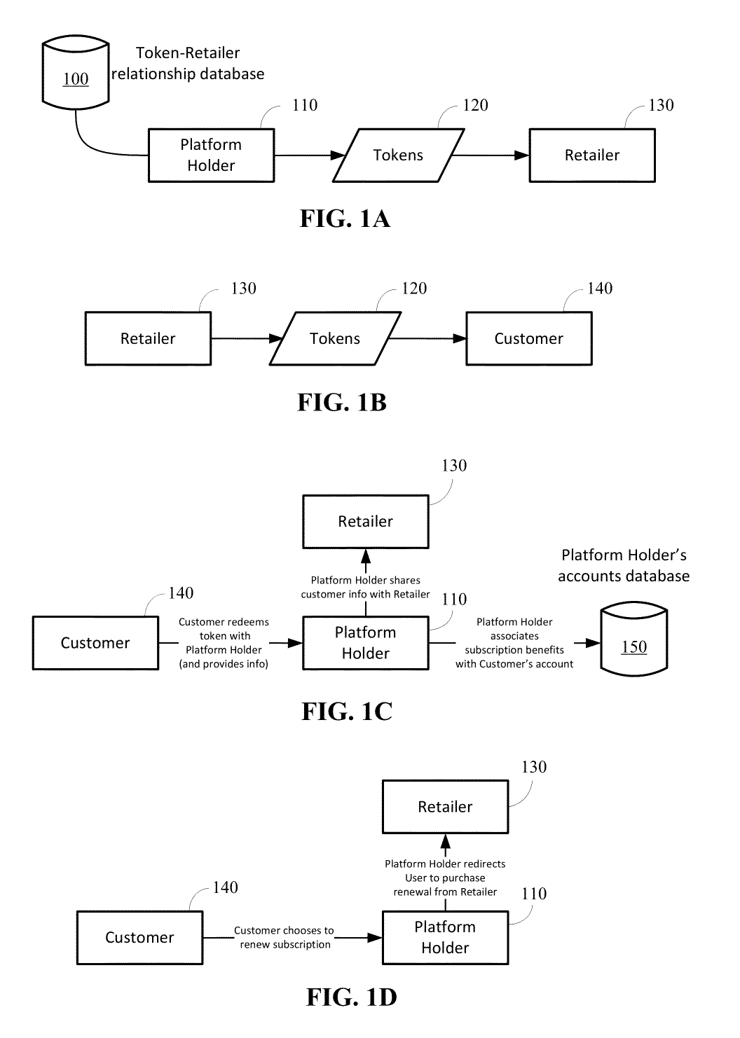

FIGS. 1A-1D illustrate a process flow for recognizing the retailer when selling token-based subscriptions.

Referring to FIG. 1A, a token-retailer relationship database 100 can be used by a Platform Holder 110 to keep track of the tokens 120 provided to a particular Retailer 130. The Platform Holder 110 may generate the tokens or use a token generating service. This process is also referred to as “minting” because a token generator may create number and/or letter keys. Once generated, the tokens may be imported into the Platform Holder's token management system in an inactive state. These tokens may be sold or provided to various parties including, but not limited to, retailers, various distributors, and even developers.

When a token 120 (or batch thereof) is sold (or otherwise provided) to the Retailer 130, the Platform Holder 110 records which Retailer those tokens were given to. The tokens 120 can include an indicator that is assigned to the particular retailer. Then, when a Customer 140 redeems that token with the Platform Holder 110, the Customer's subscription is associated with that Retailer. Thus, when a Platform Holder 110 sells tokens to a Retailer 130, the Platform Holder 110 associates those tokens with that Retailer 130 by storing the relationship in the database 100.

Referring to FIG. 1B, a Customer 140 can purchase the token 120 from the Retailer 130. The Retailer 130 may utilize a variety of CRM platforms to manage the ongoing relationship with the Customer 140, including those arising from selling entitlements to renewable subscriptions.

Referring to FIG. 1C, the Customer 140 can redeem the entitlement associated with the token 120 with the platform holder 110 through an existing account or a newly created one. The Platform Holder 110 stores the account information in a database 150. This account is used to identify the Customer 140 (and the corresponding product or service), and can be referred to as a subscription identifier (subscription ID or SID). The SID account identity is not the same one as used by the Retailer 130 (but there may be scenarios in which the Platform Holder 110 and the Retailer 130 use a same account identity). The Customer's account can then be used to check what products and/or services the Customer 140 is eligible to access. That is, the Platform Holder 110 provisions the Customer's account with the subscription benefits.

The Customer 140 may provide the contact information directly to the Platform Holder 110 in addition to or instead of at the Retailer 130. In some cases, the person redeeming the token may be different than the person who purchased the token. In some cases, the Customer 140 may choose to not provide their information at the Retailer 130 or incorrect information may have been provided. The Customer's contact information is generally provided correctly to the Platform Holder 110 and at least in a manner that enables the Customer 140 to receive the product and/or service from the Platform Holder 110.

The Platform Holder 110, with permission from the Customer 140, can provide the Customer's contact information to the Retailer 130. The Retailer 130 will then be in a position to contact the Customer 140, for example to encourage the Customer 140 to renew their subscription. In another implementation, the Platform Holder 110 may provide an API to receive from the Retailer 130 a customized communication that the Platform Holder 110 may show to the Customer 140. Thus, the Retailer 130 may communicate with the Customer 140 via its own website and/or established marketing email system used for communication with its customers; or the Retailer 130 may provide content to the Platform Holder 110 to message to customers on the Retailer's behalf.

As illustrated by FIG. 1D, an entry point to a subscription renewal provided by the Platform Holder 110 involves the Retailer 130 so that the Customer 140 can renew the subscription via the Retailer 130 instead of the Platform Holder 110. As part of the renewal process, the Customer 140 may be asked to sign in to their account with the Platform Holder 110. The Platform Holder 110 can redirect the customer 140 to purchase the renewal from the retailer 130. For example, the subscription renewal can include a link to a website hosted by the Retailer 130. The Retailer 130 can handle the payment and billing aspects of the renewal and inform the Platform Holder 110 that the subscription is renewed. The Platform Holder 110 can then provision the correct Customer's account with the appropriate subscription benefits and similarly deprovision those benefits if the customer chooses not to renew their subscription.

In another implementation, the Customer 140 may communicate directly with the Retailer 130 for renewing the subscription and the Retailer 130 communicates with the Platform Holder 110 on behalf of the Customer 140 via a renewal API of the platform system (of the Platform Holder 110).

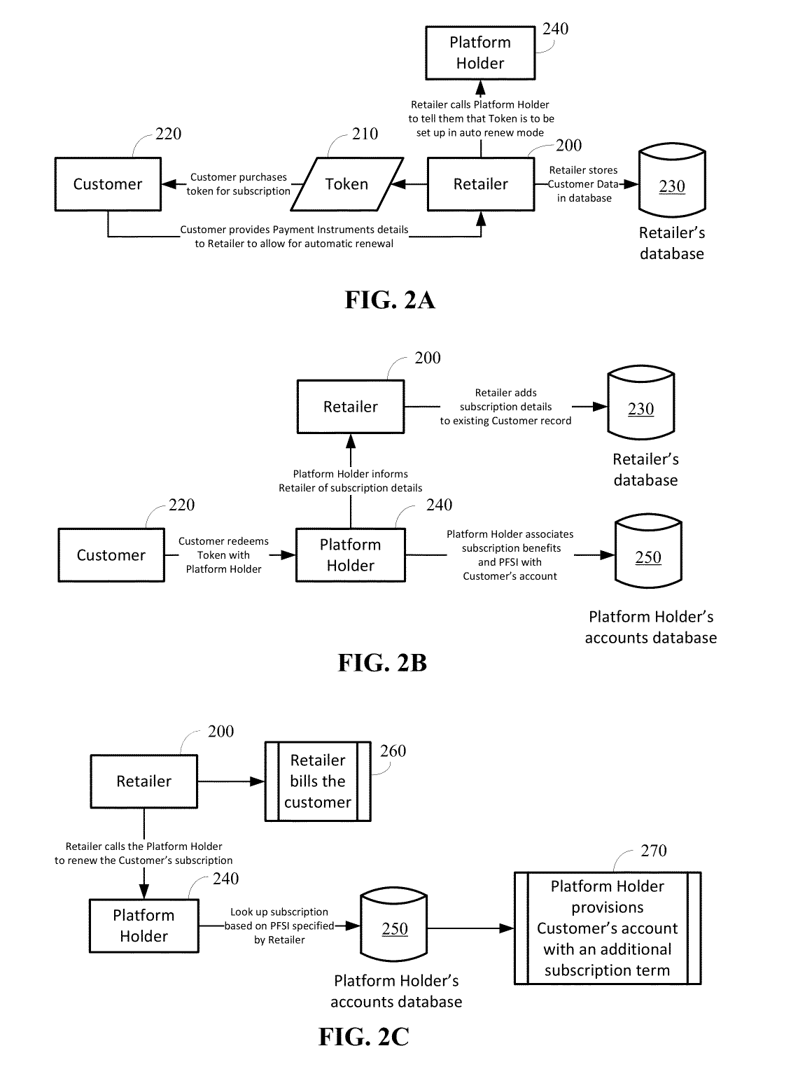

FIGS. 2A-2C illustrate a process flow for facilitating renewal of subscriptions via a retailer.

Referring to FIG. 2A, when a Retailer 200 is selling a token 210 to a Customer 220, the Retailer 200 may optionally ask the Customer 220 if the Customer 220 would like the subscription to be automatically renewed at the end of its term. If the Customer 220 agrees, the Retailer can collect the Payment Instrument details of the Customer 220 and store the Customer data of the Payment Instrument details in the Retailer's database 230. Then, the Payment Instrument details can be used to bill the Customer 220 when the subscription is to be automatically renewed. A Payment Instrument refers to a Customer's credit card or other details to allow the Retailer 200 to bill the Customer 220.

In some implementations, to arrange the subscription as an automatic renewal subscription, the Retailer 200 calls an API exposed by the Platform Holder 240 to inform the Platform Holder 240 that the token 210 that was sold to the Customer 220 is to be set up in automatic renewal mode. The automatic renewal mode may include an indication that the token is associated with the Retailer. For example, in some cases, the token may not be pre-assigned with entitlements that indicate a renewable benefit. Thus, the Retailer 200 may inform the Platform Holder 240 of the type of benefit that is to be redeemed via the token 210.

The benefit can also be referred to as an “offer,” which is the representation of the entitlements/benefits that a user may be provisioned with upon redemption of the token. The offer may be an automatic renewal subscription or a non-renewing subscription. The mode for the subscription (automatic renewal or non-renewing) can be set when the Retailer 200 informs the Platform Holder 240 of the sale of the token. An automatic renewal subscription can include experiences for the user specific for that scenario whereas a non-automatic renewal subscription can include experiences for the user specific for that scenario. For example, a link to “Set up auto-renew” may be exposed to users that are provisioned with a non-automatic renewal subscription, but omitted for user's provisioned with an automatic renewal subscription. Users provisioned with non-automatic renewal subscriptions may also be exposed to expiration warnings when their subscription is soon to expire.

Referring to FIG. 2B, when the Customer 220 redeems their token with the Platform Holder 240, the Platform Holder 240 can provision the Customer's account with the subscription benefits and can generate a Partner-Facing Subscription ID (PFSI), a unique identifier that can be used by the Retailer 200 and the Platform Holder 240 as a way to identify an individual Customer's subscription. The Platform Holder 240 can associate the subscription benefits with the Customer's account and can store the PFSI for future reference in the Platform Holder's accounts database 250.

The Platform Holder 240 can call an API exposed by the Retailer 200 to provide the Retailer 200 with subscription details including the PFSI; subscription expiration date; and the identifier of the token that the Customer 220 redeemed.

The Retailer 200 can associate the PFSI (and other information) specified by the Platform Holder 240 with the Customer's existing records stored in the Retailer's database 230, such as the Payment Instrument details that the Retailer 200 already has on file. With this information, the Retailer 200 can monitor and manage the Customer's subscription and its renewal date.

Referring to FIG. 2C, the Retailer 200 can bill (260) the Customer 220 by charging the Payment Instrument they have on file for the Customer 220 (e.g., stored in the Retailer's database 230). The billing (260) of the Customer 220 using the information on file for the Customer 220 can be performed automatically where the Customer 220 has approved automatic renewals of a subscription. The automatic renewal may be performed on the date of subscription expiration or on another specified date. In some implementations, renewal is performed in response to a renewal request by the customer on or before a specified date. For example, the Retailer 200 may have emailed a notice to the Customer 220 that the expiration of the subscription will occur on a certain date and included a prompt to renew. The Customer 220 may respond to the prompt and enter the payment instrument information at that time. Then, the Retailer 200 can bill the Customer 220 by charging the payment instrument provided by the customer in response to the renewal notice.

Upon an indication that the Payment Instrument was successfully charged, the Retailer 200 can call an API exposed by the Platform Holder 240 to cause the subscription to be renewed by an additional term. As part of the API call, the Retailer 200 provides the PFSI in order to identify which subscription the Platform Holder 240 should renew. The Platform Holder 240 can look up the subscription in the Platform Holder's accounts database 250 based on the PFSI specified by the Retailer 200 and then provision the Customer's account with an additional subscription term (270).

The additional/renewed subscriptions may include upgraded subscriptions, for example, an upgrade from a standard to a premium subscription. In one implementation, a Retailer 130 may upgrade a subscription as part of a renewal by canceling the original standard subscription and simultaneously provisioning a new subscription with a token associated with a premium service.

In some cases the Platform Holder 240 can periodically invoice the Retailer 200 for the value of all the subscriptions that were automatically renewed in this manner. In other cases, the Retailer 200 can provide payment at the time of calling the Platform Holder 240 to renew the Customer's subscription.

As described above, the token (or batch thereof) includes an identification of the retailer to which that token is associated. This identification is not simply used as an auditing or accounting mechanism. Because a token is associated with a particular retailer, when the token is redeemed, the identification of the retailer is transferred from the token to the subscription being redeemed. The subscription is then stored with an indication of the retailer (even when the token is discarded).

Embodiments of the invention enable a paradigm shift to allow the retailer to manage the CRM relationship with their customer with respect to a subscription to a product or service beyond the point of sale of the product or service. Because the ongoing relationship for a subscription service or product remains with the retailer, certain aspects of the product or service can be based on which retailer the subscription is associated with.

The Retailer identification aspect of the token can enable the Platform Holder (or product/service provider) to customize the user experience based on the retailer that the subscription was purchased from. This customization may be predefined by the particular product/service provider or a feature provided by the Platform Holder when the software package for the product or service is presented to a customer.

In general, when a user launches or otherwise accesses the software acquired from a Platform Holder, the software typically connects to the Platform Holder's servers to validate its license state (to ensure it is correctly licensed). Implementations include the retailer identifier and PFSI along with an indication of the license state in the response to the software's call to the Platform Holder's servers. The calling software can then provide a tailored experience based on the Retailer it was purchased from.

For example, the software can inform users that their subscription is about to expire. Instead of linking customers to renew their subscription ‘directly’ with the Platform Holder, the software can link users to a website of the Retailer, which may offer the option to the customer to renew their subscription. The software (product or service being used by the customer) can pass to the retailer the user's PFSI. The Retailer can then cross-reference this with their existing database so that they would know which customer's subscription to renew.

In some cases, the “chrome” of a particular software product or service may be specific to the retailer. Chrome refers to the visual design elements that often surround content (e.g., user data, web page, or other content) on a screen and provide the information about or commands to operate on the screen's content.

According to certain implementations, the software can be customized based on the retailer that sold the subscription. In addition, targeted information can be provided. Certain implementations enable the Retailer to handle billing, pricing, special offers, messages, advertising and other CRM features through the identifier associated with the token. The identifier and customized-for-the-retailer packaging enables differentiation of experience for the user.

As an illustrative example, a customer may purchase a subscription to Microsoft Office 365® from Best Buy in the form of an entitlement card (or other item) with a token configured to indicate that the purchase is from Best Buy and that the entitlement is a renewable subscription for Microsoft Office 365®. When the customer redeems the token and launches Office365®, the version (or package chrome) for Office365® is customized for Best Buy. That is, a user's subscription to Office365® can be associated with Best Buy and the chrome for Office365® (e.g., the ribbon, toolbars, and other specialized panes) modified specifically for Best Buy.

In one such case, a Best Buy specific ribbon or toolbar may be provided to enable renewal with a renewal button or tab directly within a Microsoft Word® or other application available through Office365®. The renewal button or tab may include a link to Best Buy. In some cases, other Best Buy products may be included or displayed as part of the chrome for the application. As an example, when the customer views the manage account page, the customer can see targeted information for Best Buy such as Best Buy—specific sales and items.

In some implementations, the API can be hosted by a platform holder and the platform holder can grant the user access to a product or service available from the platform holder entity or a third-party entity. For example, where the platform holder is the Windows® App Store available from Microsoft Corp., and the Windows® App Store provides certain Apps for purchase on a subscription basis, the App Providers (either Microsoft Corp. or another provider) can sell their Apps in retailers. The retailer versions include a code to be redeemed with the platform Holder and then the platform holder grants the user access to the App for the duration of the subscription.

The platform holder system can be configured to enable Apps (products and services) to be sold via retailers on an automatic renewal basis, as well as a regular non-auto-renewing basis. The platform holder system can allow third-party providers to sell subscriptions to their products/services via retailers.

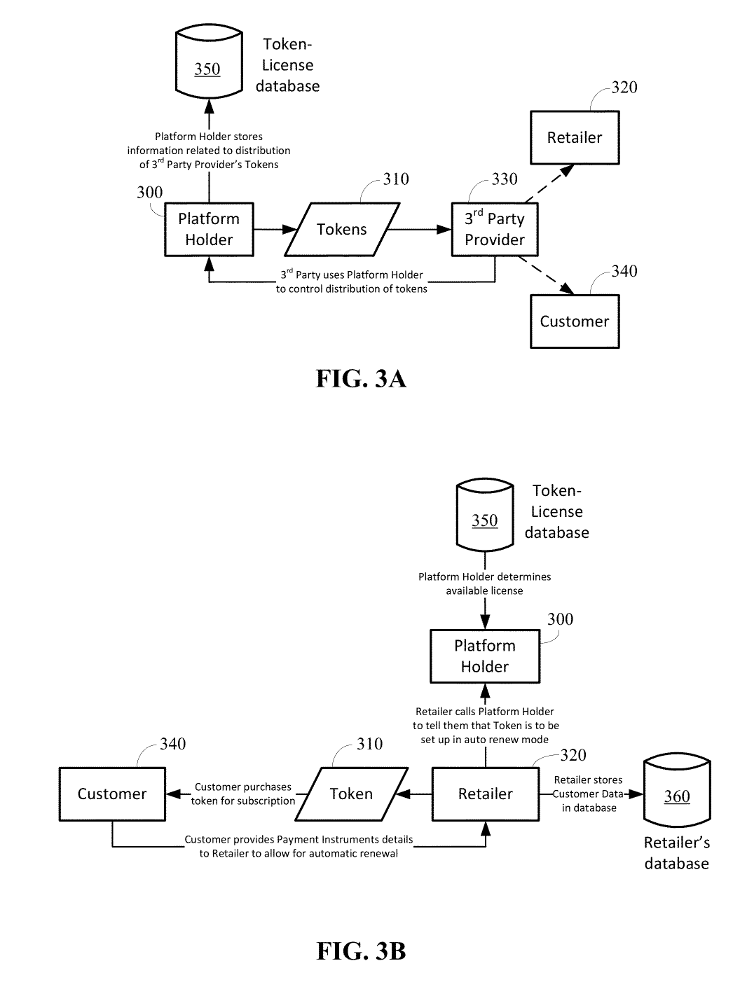

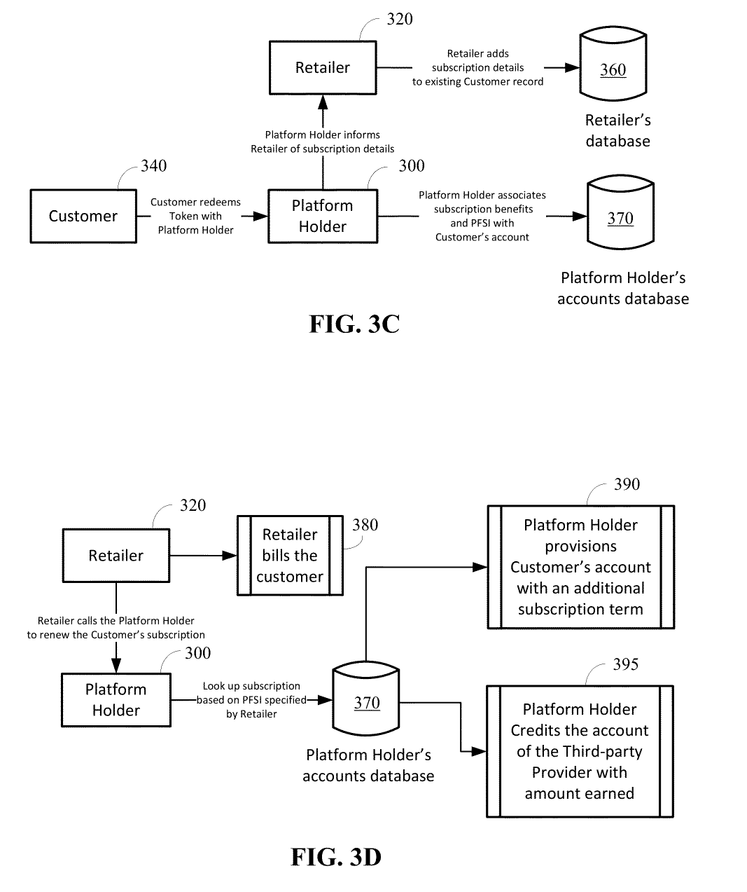

FIGS. 3A-3D illustrate a process flow for facilitating renewal of third-party subscriptions via a retailer. Referring to FIG. 3A, the Platform Holder 300 can produce tokens 310 to be sold via Retailers 320, which redeem the products/services of a Third-party Provider 330 whose products/services are available via the Platform Holder's ‘app store’ or other distribution platform. For example, the Third-party Provider 330 can purchase tokens 310 from the Platform Holder 300 and then use the Platform Holder 300 to control distribution of tokens. The Platform Holder 300 can store information related to distribution of Third-Party Provider's tokens in a Token-License database 350. This database 350 may be the same database used to store first party license information.

The Platform Holder 300 may optionally also allow Third-party providers to purchase tokens for their own products, which may then be sold to Customers 340 either directly or via a Retailer 340.

The cost to the Third-party Provider 330 for creating a token could be calculated based on the percentage cut that that Platform Holder 300 takes from sales or other measure according the distribution agreement between the platform holder and the Third-party Provider 330 for placing the product or service from the Third-party Provider 330 in the Platform Holder's App Store. For example, if a subscription sells for $100 and the Platform Holder normally receives 20% of the sale, the Platform Holder 300 may sell the tokens to the Third-party Provider for 20% of the normal cost (in this case $20). The Third-party Provider could then sell the tokens to Retailers 320 or directly to Customers 340 without using the Platform Holder 300 as the portal to access the Third-party Provider's product or services. Unlike when the Platform Holder 300 sells subscriptions directly, the Third-party Provider 330 is not reimbursed by the Platform Holder 300 in the direct to customer or direct to retailer scenarios.

Similar to that described with respect to FIGS. 1A-1D and 2A-2C, the Platform Holder 300 can identify and record the subscriptions purchased from the various Retailers. In addition, Retailers can sell automatically-renewing subscriptions to the Third-party Provider's products and services through the Platform Holder 300.

For example, referring to FIG. 3B, when a Retailer 320 is selling a token 310 associated with a Third-party Provider 330 to a Customer 340, the Retailer 320 may optionally ask the Customer 340 if the Customer 340 would like the subscription to be automatically renewed at the end of its term. If the Customer 340 agrees, the Retailer 320 can collect the Payment Instrument details of the Customer 340 and store the Customer data of the Payment Instrument details in the Retailer's database 360. Then, the Payment Instrument details can be used to bill the Customer 340 when the subscription is to be automatically renewed (or upon prompting of the Retailer 320).

To establish that the subscription is an automatic renewal subscription, the Retailer 320 calls an API exposed by the Platform Holder 300 to inform the Platform Holder 300 that the token 310 that was sold to the Customer 340 is to be set up in automatic renewal mode. The Platform Holder 300 can confirm the conditions for setting up automatic renewal mode for the Third-party Provider's product or service from the token-license database 350.

Referring to FIG. 3C, when the customer 340 redeems their token with the Platform Holder 300, the Platform Holder 300 can provision the Customer's account with the subscription benefits and can generate a PFSI that can be used by the Retailer 320 and the Platform Holder 300 as a way to identify an individual Customer's subscription. The Platform Holder 300 can associate the subscription benefits with the Customer's account and can store the PFSI for future reference in the Platform Holder's accounts database 370.

The Platform Holder 300 can call an API exposed by the Retailer 320 to provide the Retailer 320 with subscription details including the PFSI; subscription expiration date; and the identifier of the token that the Customer 340 redeemed.

The Retailer 320 can associate the PFSI (and other information) specified by the Platform Holder 300 with the Customer's existing records stored in the Retailer's database 360, such as the Payment Instrument details that the Retailer 320 already has on file. With this information, the Retailer 320 can monitor and manage the Customer's subscription and its renewal date.

Referring to FIG. 3D, the Retailer 320 can bill (380) the Customer 340 by charging the Payment Instrument they have on file for the Customer 340 (e.g., stored in the Retailer's database 360). The billing (380) of the Customer 340 using the information on file for the Customer 340 can be performed automatically where the Customer 340 has approved automatic renewals of a subscription. The automatic renewal may be performed on the date of subscription expiration or on another specified date. In some implementations, renewal is performed in response to a renewal request by the Customer 340 on or before a specified date. For example, the Retailer 320 may have emailed a notice to the Customer 340 that the expiration of the subscription will occur on a certain date and included a prompt to renew. The Customer 340 may respond to the prompt and enter the payment instrument information at that time. Then, the Retailer 320 can bill the Customer 340 by charging the payment instrument provided by the Customer 340 in response to the renewal notice.

Upon an indication that the Payment Instrument was successfully charged, the Retailer 320 can call an API exposed by the Platform Holder 300 to cause the subscription to be renewed by an additional term. As part of the API call, the Retailer 320 provides the PFSI in order to identify which subscription the Platform Holder 300 should renew. The Platform Holder 300 can look up the subscription in the Platform Holder's accounts database 370 based on the PFSI specified by the Retailer 320 and then provision the Customer's account with an additional subscription term (390).

When a Third-party Provider's subscription is automatically renewed by a Retailer 320, the Platform Holder 300 may credit the account (395) of the Third-party Provider 330 with the amount earned (typically a percentage of the total cost of the subscription renewal). The Platform Holder 300 may periodically pay out to the Third-party Provider 330.

Third-party Providers can sell automatically renewable subscriptions via retail channels where the products or services are fulfilled by the platform holder. As an illustrative example, through implementations of systems described herein, the Instapaper® bookmarking and reading web service premium subscription for the iPad® may be purchased at a Retailer such as Best Buy. Apple Inc. would be the entity fulfilling the order since it is available in the Apple iTunes App Store. The Platform (e.g., Apple® iTunes® App Store) controls access to the product, the product is provided by the Third-party provider (Instapaper) and the Retailer (Best Buy) manages the billing and charges the Customer's credit card.

This approach is not just for App stores; it also enables retailers of other forms to sell the renewal instead of the platform holder. For example, online retailers can sell multiple items in a cart at once where one item is a multiple renewal subscription and, if other items are in the cart, another item may be something else. For example, Amazon.com can sell the Microsoft Surface Pro® and a Microsoft Office365® subscription configured for an automatic renewal during the same transaction. Both items may be placed in the check-out cart.

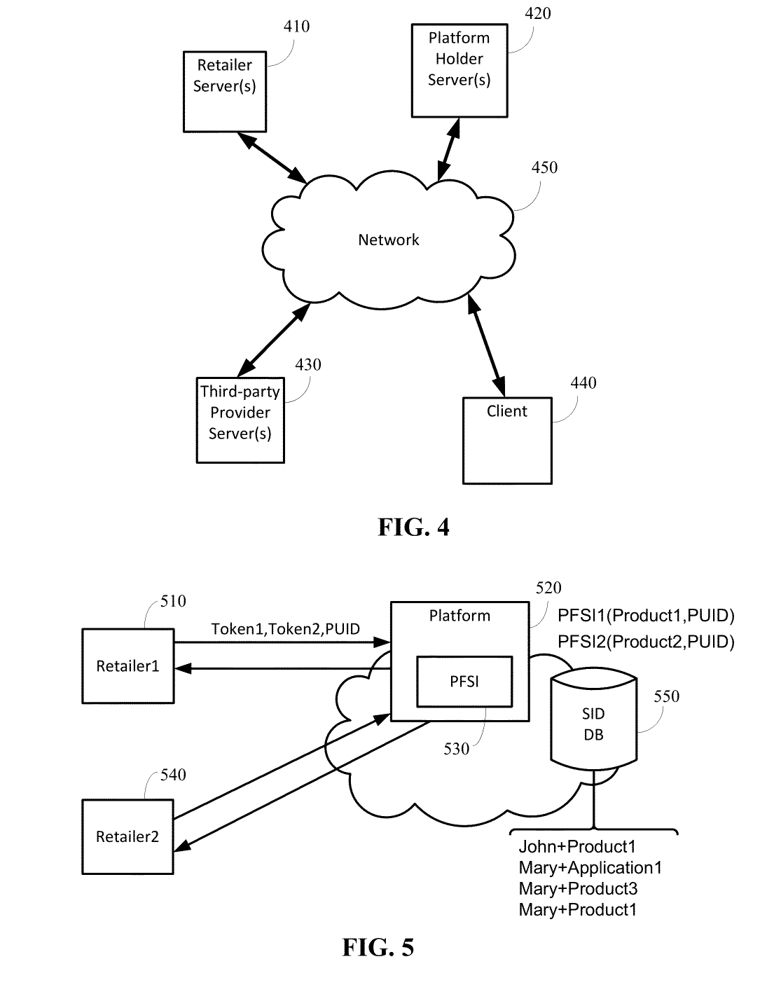

FIG. 4 illustrates a general operating environment. Referring to FIG. 4, Retailer device(s) or server(s) 410, Platform Holder device(s) or server(s) 420, Third-party Provider device(s) or server(s) 430, and client device(s) 440 may communicate with each other over a network 450.

Retailer device(s) or server(s) 410, Platform Holder device(s) or server(s) 420 and Third-party Provider device(s) or server(s) 430 can involve computing systems configured with one or more central processing units (CPUs), memory, mass storage, and I/O devices (e.g., network interface, user input device). The hardware platform of computing systems can be embodied in many forms including but not limited to, a personal computer, a server computer, a hand-held or laptop device, a multiprocessor system, a microprocessor-based system, programmable consumer electronics, and a distributed computing environment (e.g., cloud-based computing systems) that includes any of the above systems or devices (and where application functionality, memory, data storage and retrieval and various processing functions may be operated remotely from each other over a distributed computing network, such as the Internet or an intranet).

In certain embodiments, the Retailer device(s) or server(s) 410, Platform Holder device(s) or server(s) 420 and Third-party device(s) or Provider server(s) 430 can each be embodied as a computing device including, but not limited to, a server computer, an enterprise computer, a personal computer, a multiprocessor system, a microprocessor-based system, and a combination thereof. It should be understood that the listing of client computing devices and the server computing devices is not intended to be limiting and that the client and server may be embodied in the same or different form.

The client device 440 can involve computing systems configured with one or more central processing units (CPUs), memory, mass storage, and I/O devices (e.g., network interface, user input device). Elements of a computing system can communicate with each other via a bus. In certain embodiments, the client device 440 can be embodied as a computing device including, but not limited to, a personal computer, a tablet, a reader, a mobile device, a personal digital assistant (PDA), a smartphone, a laptop (or notebook or netbook) computer, a gaming device or console, a desktop computer, or a smart television.

The network can include, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

FIG. 5 illustrates an operating environment in which certain implementations may be carried out. Referring to FIG. 5, a Retailer 510 (for example via a computing device) can send a token and customer identifier (such as a personally unique identifier (PUID) associated with a Microsoft-related account) to a Platform 520. The Platform 520 can establish a subscription for the customer identified by the customer identifier in the system and generate a PFSI via a PFSI generator 530. This PFSI can be provided to the Retailer 510 so that the Retailer 510 can reference the number for later. A method of managing a new subscription can include receiving the token and user id and using that information to map to an internal database. If nothing matches, the system can generate a new PFSI (via PFSI generator 530) and provide it to the appropriate Retailer.

The PFSI ties together the subscription information, the product information, the relationship owner (Retailer) information and the customer identification. Each product has its own PFSI. For example, two tokens may be sent by the Retailer 510 as part of a customer's order. Each token is specific to a product. The customer identifier (e.g., PUID) is provided so that the platform 520 knows who the product is associated with. In some cases, the customer identifier is omitted, particularly where the customer does not provide their information upon purchase at the Retailer (but does provide the information upon redemption). Once the customer identifier is received by the platform (either via the Retailer or via the Customer when the Customer redeems the token), the platform may create a PFSI with product name and user identifier. PFSI protects a user's information from leaking between Retailers, for example, between the Retailer 510 and another Retailer 540.

For the example, (Product1, PUID) is assigned to PFSI1 and (Product2, PUID) is assigned to PFSI2. An example is illustrated in FIG. 5, where four SIDs—in the form of customer identifier and product name—(John+ Product1; Mary+ Application1; Mary+ Product3; and Mary+ Product1) are stored in a SID database 550. Although the SID is described with only a product name and customer identifier, it should be understood that the SID can include further information. For example, further granularity of the product and benefits can be included. In some cases, the benefit the user receives may change over time. Certain offers may include more or fewer valuable services and these may fluctuate over time and those assigned to the user may depend on when the user redeems a token for the benefits indicated on an entitlement card (or other package).

Each SID has a corresponding PFSI. The SID is separate from the PFSI—it is unique to customer, product, and Retailer. The SID can stay the same, but the PFSI may change if the user goes to a different Retailer. The SID DB 550 may be internal for the platform (or privately accessed by the platform) and stores the SIDs. A separate database or mapping function maps the SIDs stored in the SID database with the PFSIs.

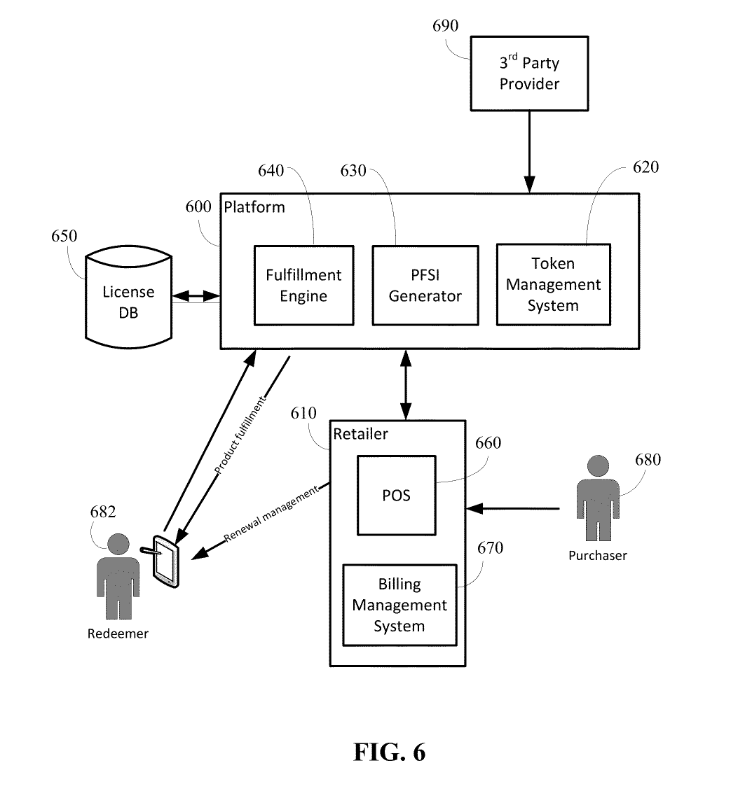

FIG. 6 illustrates an operating environment in which certain implementations may be carried out. Referring to FIG. 6, the operating environment includes a platform system 600 and Retailer system 610. The platform system 600 can include a token management system 620, a PFSI generator 630, and a fulfillment engine 640. The platform system 600, token management system 620, PFSI generator 630, and fulfillment engine 640 may include software applications running on a same device, running on separate devices, distributed across multiple devices or accessed over a network in a server/client configuration. The platform system 600 may also include a license database 650 (similar to the platform Holder's accounts database and/or SID database). Other databases may also be included, such as the token-retailer relationship database 100 as described with respect to FIG. 1A.

The Retailer system 610 can include a point of sale (POS) device 660 and a billing management system 670. The retailer system 610, POS device 660, and billing management system 670 may include software applications running on a same device, running on separate devices, distributed across multiple devices or accessed over a network in a server/client configuration.

The platform system 600 may also include an accounting system (not shown) that enables management of retailer-controlled renewals of subscriptions. For example, the retailer receives money for the initial sale of an entitlement card via POS device 660. The accounting for the sale of the entitlement cards/tokens can be maintained by the accounting system. Depending on the arrangement, the retailer may pre-pay for the tokens that will be sold or provide payment after selling the tokens. The billing management system 670 can manage the retailer-customer billing relationship and handle the transactions between the retailer and customer for the subscription renewal. Because the retailer receives the money from the customer for the renewal, the retailer then provides an amount to the platform holder. The accounting system can be used to keep track of the money owed for provisioning the renewal term of a subscription. The accounting system can also be used to track and credit Third-party provider accounts for sales of their subscriptions.

The platform system 600 may be embodied as part of a cloud service or a web service for syndicating subscriptions with retailers. The cloud or web services (for syndicating subscriptions with retailers), including the platform system 600 may be implemented using one or more physical and/or virtual servers communicating over a network.

A cloud service generally refers to hosted services providing scalable processing and storage capabilities. Web services can be provided and/or hosted by a cloud service (e.g., as part of a large-scale distributed computing environment). A web service is a software system that supports interoperable machine-to-machine interaction over a network and enables software to connect to other software applications.

A web service provides a collection of technological standards and protocols. For example, a web service provides functions that may be implemented by a software or hardware agent that sends and receives messages (e.g., the computing platforms requesting and providing a particular service). Applications can access web services via ubiquitous web protocols and data formats such as hypertext transfer protocol (HTTP), XML, JavaScript Object Notation (JSON), Representational state transfer (REST) protocols, and SOAP.

The retailer server(s) and computing devices of the retailer system 610 and the platform system 600 may communicate with each other via one or more of the web protocols and data formats described above.

As illustrated in FIG. 6, a customer 680 can purchase or receive an entitlement card (or other instrument providing a token) via the retailer system 610. The point of sale 660 at the retailer may be online, in a store, at a kiosk, or any suitable location having a computing device from which the entitlement card sale to the customer can be reported to an order management system of the platform system 600. The retailer system 610 interfaces with customers to receive payment for products and services including subscriptions and their renewals (automatic or prompted).

Although the customer 680 may provide the Retailer with the correct payment information (in order to tender the sale at the time of purchase), the customer may not have provided their customer identifier (or the customer identifier of the person receiving the benefit) or other account information for the product or service. To minimize errors due to incorrect information at tender, the platform system 600 may delay provisioning the benefits for a token until redemption. Then, at that time, the platform system 600 may contact the retailer system 610 to provide the PFSI (generated by the PFSI generator 630).

In some cases, redemption may occur at tender, for example, when a customer 680 redeems at check-out (becoming the redeemer 682). This may be accomplished, for example, by a 2D or 3D barcode (e.g., universal product code (UPC), QR (quick response) code or high capacity color barcode) that the customer has associated with their account and the retailer system 610 can scan to enter the information. Alternatively, the 2D or 3D barcode may be generated by the retailer system 610 and the customer may scan the code to launch a site for entering their information (for example, via their mobile computing device such as a phone, smart watch, or tablet). In some cases, these two scenarios may be carried out using a pin number and a touch pad (or touch screen). Other scenarios are contemplated for facilitating the exchange of information.

The retailer system 610 including the computing device for the point of sale (POS) 660 can inform the platform system 600 that a token has been sold and the platform system 600 may provide an indication that the sale has been received. Additional information may be sent from the platform system 600 to the retailer system 610 after the token is redeemed or further activated by the redeemer 682. The retailer system 610 can call a service operated by the Platform system 600. As part of the call, the retailer system 610 can indicate that a card is sold.

The Platform system 600 can receive indication that a card configured for a particular Retailer renewal is sold. The platform system 600 can generate or update a PFSI through the PFSI generator 630 at the time of sale or wait for the customer to redeem the token contained on (or otherwise associated with) the entitlement card. Once the PFSI is generated, the platform system 600 can inform the retailer system 610 of the PFSI

When the customer-redeemer 682 redeems the token, the platform system 600 can confirm that the token is valid by checking the license database 650 and provision the benefits (e.g., the subscription) through the fulfillment engine 640.

The platform system 600 can support APIs that enable Third-party providers 690 and even retailers to use the platform system's token management capabilities. An API can be provided for token generation. For example, a Third-party provider 690 may call the platform's token generation API to request tokens be generated for their product or service. An API of the platform system may include a package customization set-up for the Third-party provider 690 to facilitate the syndication of their product or service in a retail channel.

As an example scenario, a Third-party provider 690 may have developed a mapping solution application that generates and stores 3D maps of a user's favorite hiking ranges. The Third-party provider 690 can call the platform system 600 to register the mapping solution application as an app for syndication to a retailer (in addition to or as an alternative to being available in the platform holder's App store). The mapping solution application may or may not be provided on a subscription basis and the Third-party provider 690 may select the scope of the license for the mapping solution application.

In one implementation, the selection may be indicated via a checkbox of a provider interface. Packaging information and other details may be made available for the platform system to provide to a retailer. The retailer (or another party) may use the packaging information sent to the platform system 600 to automatically or by a manual process create the packaging for the mapping solution application. The retailer can then sell the entitlement card or other item carrying the token and use the packaging for the mapping solution to customize the mapping solution for their retail store.

The customer 680 then pays the retailer to purchase the entitlement to the mapping solution application. The customer may redeem the entitlement at the platform 600, for example through the fulfillment engine 640. The platform fulfills the order after determining that the license is available in the license database 650, which includes the licenses for the Third-party developer/provider as well as any First-party products and services (developed by the Platform Holder). When the user launches the mapping solution application, the mapping solution application contacts the platform 600 to request if the user has a license to run the application. Here, the platform manages the licenses (and the tokens). In one approach, the user may click to buy the mapping solution in the platform's app store. At this point, they may click to enter the token code that is printed on their retail receipt or that is contained in the box/package sold.

The retailer system 610 can support renewal of the subscription for the customer redeemer 682 through the billing management system 670. The retailer system 610 may communicate with the platform system 600 that the subscription has expired (due to non-payment) or, if the platform system 600 has not received renewal indication from the retailer by certain date or amount of time, the subscription may automatically expire.

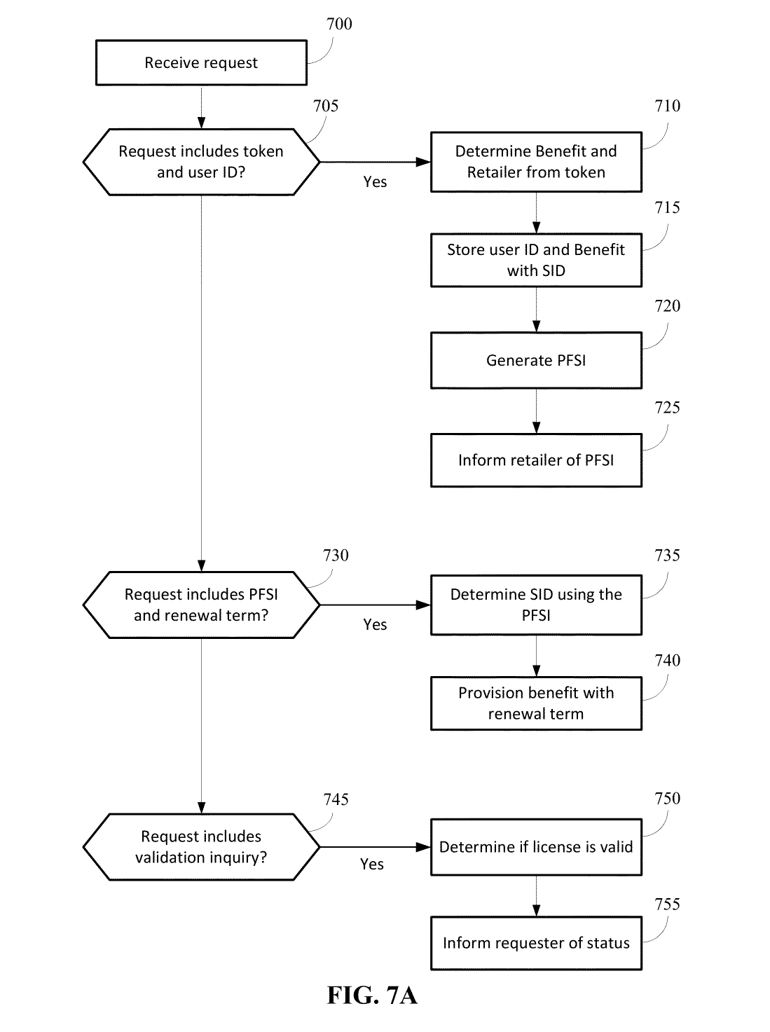

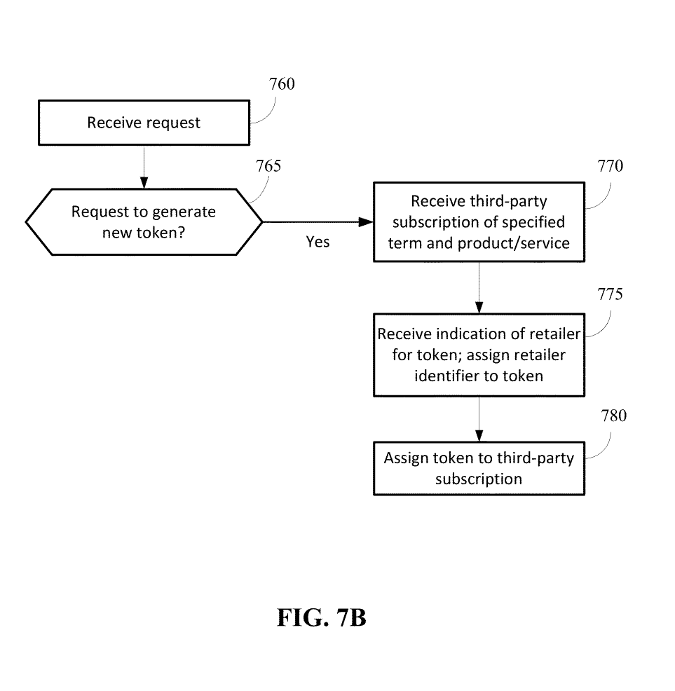

FIGS. 7A and 7B illustrate implementations of a method for facilitating syndication and renewal of subscriptions via a retailer. A request may be received by a platform system (700). When the request includes a token and user identifier (705), the system can determine the benefit and retailer associated with the token (710). This may be accomplished by looking up a token database. The user identifier and benefit can be stored with a subscription identifier (SID) in an accounts/license database (715). A PFSI can also be generated (720). The PFSI is used for external purposes and may help maintain privacy of a user's information. The PFSI can be stored associated with the SID and also provided to the retailer for their records (725).

When the request includes the PFSI and a renewal term (730), the system determines the SID using the PFSI (735) and provisions the benefit associated with the SID with the renewal term (740). Payment can be handled between the retailer and the platform holder since the customer pays the retailer for the renewal instead of the platform holder.

When the request includes a validation inquiry (745), which may occur in scenarios where a product or service is confirming that a user has a valid license, the system can determine whether the license is valid (750), for example by determining if the subscription is still within the term. This may be accomplished by using the user id and benefit information (provided by the product or service) to look-up the information in the SID/license database. The valid/invalid state may be provided to the requester (755).

Accordingly, in response to receiving a request to redeem a token configured with a retailer identifier, the account may be set-up, a PFSI can be generated and the retailer can be informed of the PFSI. In some cases where the request includes the token or token and user ID from the retailer, the token may be assigned to an automatic renewal mode (for example in the token database such as described with respect to FIG. 1A).

Further, in response to receiving a request to update a subscription for a specified PFSI, the subscription benefits corresponding to the specified PFSI can be updated with the renewal term. This can be accomplished through the retailer by using the PFSI instead of the user ID, which may not be known to the retailer.

FIG. 7B illustrates additional steps that may be incorporated for third-party subscriptions. Referring to FIG. 7B, a request can be received by the platform system (760). When the request is to generate a new token (765), a token can be minted. The request may include information, such as a specified term and product/services, for a third-party subscription that is to be managed via the platform system (770). The retailer that will be selling the token can be provided and a retailer identifier can be assigned to the token (775). The generated token can be assigned the third-party subscription (780).

Thus, in response to receiving a request to generate a new token for a third-party subscription for a specified term to a product or service, the new token can be assigned to the third-party subscription.

In addition to online goods and services, implementations may be available for syndication of subscriptions to non-digital goods and/or services.

The systems described herein can be adapted with minimal modifications to support the syndication of subscription to non-digital goods and/or services. Examples of non-digital goods and services include, but are not limited to, gym memberships, magazine or newspaper subscriptions, and coffee-of-the-month clubs. In some implementations of this model, the Customer may not interact with the Platform Holder at all. Instead, they would purchase a token from a Retailer and redeem it directly with a Third-party Provider. The Third-party Provider would utilize the resources of the Platform Holder for token generation and/or management.

The provider of the physical subscription services (e.g. the gym, magazine publisher, etc.) may also be referred to as a Third-party Provider.

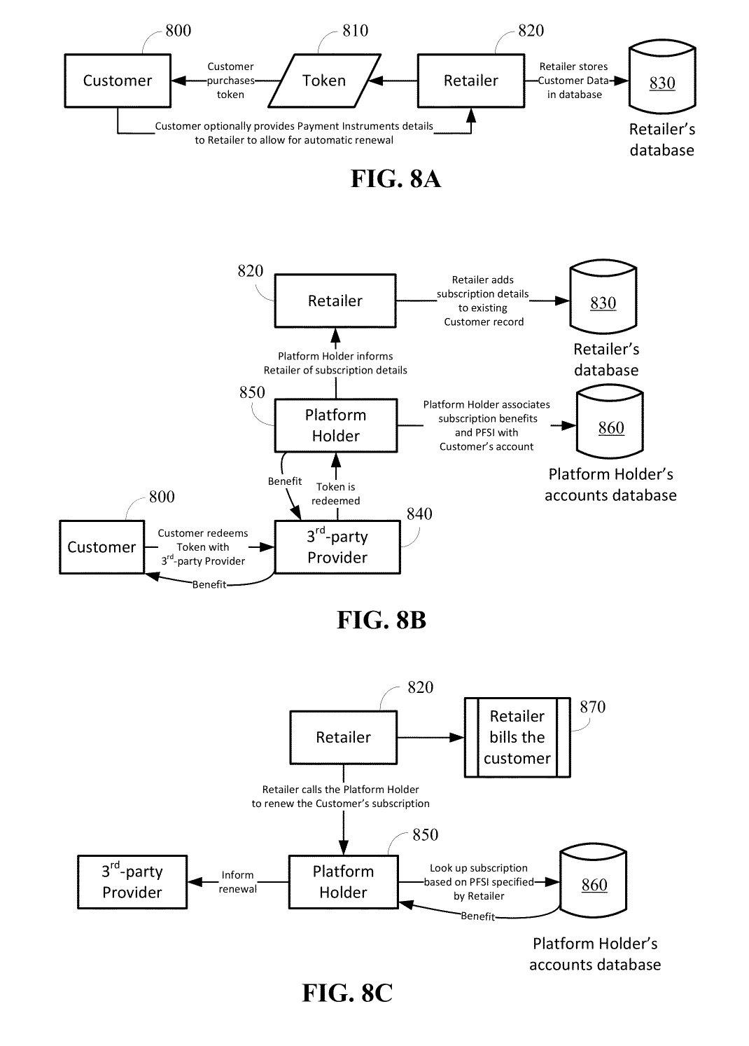

FIGS. 8A-8C illustrate a process flow for facilitating renewal of non-digital third-party subscriptions via a retailer. The Third-party Provider can contact the Platform Holder to create tokens that correspond to a subscription service or product offered by the Provider, similar to the scenario illustrated in FIG. 3A. These tokens can be packaged in the form of an entitlement card or other item to be sold at a Retailer. Referring to FIG. 8A, a Customer 800 may purchase a token 810 (in the form of an entitlement card or other item) from the Retailer 820. The Retailer 820 may optionally set up the token as auto-renew by collecting and storing the Customer's Payment Instrument details in the Retailer's database 830.

Referring to FIG. 8B, a Customer 800 who purchases such a Token 810 may redeem the token 810 through the Third-party Provider 840 (either in person or to the Provider's website). The Provider 840 may then contact the Platform Holder 850 to ‘redeem’ the token. The Provider 840 can specify the token to the Platform Holder 850. In addition, for scenarios where the Customer may have not provided contact and payment information to the Retailer at the time of purchase, the Third-party Provider 840 may collect this information and provide it to the Platform Holder 850. The Platform Holder 850 can perform a look-up in the Platform Holder's accounts database 860 for the token.

In some implementations, a PFSI may be generated and shared with the Retailer 820 who then adds the subscription details to the Retailer's database 840. If the token has not previously been used, the Platform Holder 850 informs the Provider 840 of the subscription benefits that the Customer is eligible for; the Platform Holder 850 then disables the token to prevent others from using it too. The PFSI may take the place of the token to indicate the user and benefits (and associated Retailer). In response to receiving an indication of the subscription benefits from the Platform Holder 850, the Provider 840 gives the Customer 800 the benefits of their subscription. In this manner, the Platform Holder 850 manages the subscription for the provider 840.

The customer may redeem the token at a service or product purchase system such as an App Store (through a platform holder) or a Store (online or brick and mortar) provided by a Third-party provider. The service or product purchase system may be available through an online portal. The person redeeming token may access the service or product purchase system through the online portal. The service or product purchase system redeems the token from the token management system (which may be provided by the Platform Holder). Upon successful redemption, the token management system returns the benefit information. In addition, once the indication of activation of the associated benefit is received, the service or product purchase system routes the request to the appropriate service or product provider (if not the same entity), which provisions the service or product. The customer now has access to the requested benefit.

Referring to FIG. 8C, if the Customer 800 opted to set up their subscription as auto-renew, then when the subscription is about to expire, the Retailer 820 may bill (870) the Customer 800 again (based on the Payment Instrument information on file). Once the Retailer 820 collects payment, the Retailer 820 may inform the Platform Holder 850 that the subscription should be renewed. The Platform Holder 850 can determine the benefit and provider referenced by the Retailer 820, for example by looking up the subscription in the Platform Holder's accounts database 860, and inform the Third-party Provider 840 that the Customer's subscription should be renewed.

As a specific example, a customer may want organic vegetables ordered every week to their house. The customer may go to a grocery store such as Costco to purchase the food delivery subscription. An organic farm co-op may use a platform holder (or other distributer that has a relationship with the grocery store) to manage the food delivery subscription and allow the grocery store to maintain the relationship with the customer. When the platform holder informs the organic farm co-op of the subscription, the organic farm co-op can deliver the organic vegetables according to the subscription. Customization of the order (including physical packaging) can be configured specific to the grocery store based on the retailer identification component of the token redeemed by a customer. Similar to the software products and services, a reliable ongoing subscription can be created for the organic farm co-op while keeping the retailer (the grocery store) in the loop.

It should be understood that the example implementations illustrated and described herein are merely to illustrate some scenarios in which embodiments may be carried out and should not be construed to limiting implementations to the illustrated examples.

Certain techniques set forth herein may be described in the general context of computer-executable instructions, such as program modules or applications, executed by one or more computing devices. Generally, program modules and applications include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Carrier waves and other propagating signals that may contain data usable by a computer system are not themselves “computer-readable storage media.”

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Example scenarios have been presented to provide a greater understanding of certain embodiments of the present invention and of its many advantages. The example scenarios described herein are simply meant to be illustrative of some of the applications and variants for embodiments of the invention. They are, of course, not to be considered in any way limitative of the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A computer-implemented method for facilitating syndication of subscriptions with retailers comprising:
in response to receiving a request to redeem a token configured with a retailer identifier, generating a Partner-Facing Subscription Identifier (PFSI), informing a retailer associated with the retailer identifier of the PFSI, and associating subscription benefits and the PFSI with a user account.

2. The method of claim 1, further comprising
assigning the token to an automatic renewal mode in response to receiving a request to assign the token to the automatic renewal mode.

3. The method of claim 1, further comprising in response to receiving the request to redeem the token, providing access to a subscription to a product or service comprising packaging for the retailer associated with the retailer identifier.

4. The method of claim 3, wherein the packaging comprises a link to a retailer website to which the retailer identifier corresponds.

5. The method of claim 1, further comprising:
in response to receiving a request to update a subscription for a specified PFSI, determining the user account and the subscription benefits corresponding to the specified PFSI and provisioning the user account with an additional subscription term for the subscription benefits corresponding to the specified PFSI.

6. The method of claim 5, further comprising crediting an account of a subscription provider for the additional subscription term.

7. The method of claim 5, further comprising receiving a credit from the retailer for the additional subscription term.

8. The method of claim 1, further comprising:
in response to receiving a request to generate a new token for a third-party subscription for a specified term to a product or service, assigning the new token to the third-party subscription, wherein the new token to the third-party subscription includes a specified retailer identifier.

9. The method of claim 8, further comprising:
in response to receiving a request to redeem the new token to the third-party subscription, activating the new token to the third-party subscription for the specified term, generating a corresponding PFSI, and providing the corresponding PFSI to the retailer associated with the specified retailer identifier.

10. The method of claim 9, further comprising:
in response to receiving a request to validate the third-party subscription, providing an activation state of the new token to the third-party subscription, wherein the activation state indicates a valid subscription or an invalid subscription.

11. The method of claim 9, further comprising:
in response to receiving a request to update a term of a subscription for the corresponding PFSI, determining the third-party subscription associated with the corresponding PFSI, and adjusting the specified term of the third-party subscription with an additional term.

12. A system for facilitating syndication of subscription s with retailers comprising:
a Partner-Facing Subscription Identifier (PFSI) generator that:
receives a user account identifier and a token comprising a retailer identifier; and
generates a PFSI; and
a fulfillment engine that receives the token and the user account identifier to activate a subscription customized based on the retailer identifier.

13. The system of claim 12, further comprising a database including subscription identifiers and corresponding PFSIs, wherein each subscription identifier identifies a user account and a product or service provisioned thereto.

14. The system of claim 12, wherein the fulfillment engine further:
receives a PFSI,
determines the user account corresponding to the PFSI, and
provisions the user account with an additional subscription period.

15. The system of claim 14, further comprising an accounting system for receiving credit for the additional subscription period from a retailer.

16. The system of claim 12, wherein the subscription customized based on the retailer identifier includes a link to a retailer website to which the retailer identifier corresponds, the link being for renewing the subscription.

17. The system of claim 12, further comprising a token management system that receives a request to generate a new token for a third-party subscription for a specified term to a product or service; assigns the new token to the third-party subscription; and stores the new token with a specified retailer identifier.

18. The system of claim 17, further comprising an accounting system for crediting an account of a provider of the third-party subscription for a renewal of the specified term.

19. An entitlement card for a subscription-based product redeemable through a platform holder and configured with a token assigned to a retailer for automatic renewal by the retailer.

20. The entitlement card of claim 19, wherein the token comprises a retailer identifier and the subscription-based product comprises a product or service customized according to the retailer.
